(19) United States
(12) Patent Application Publication
(10) Pub. No.: US 2026/0217739 A1
(43) Pub. Date: Jul. 30, 2026

(54) HYDROSILYLATION PROCESS CATALYSED BY A MANGANESE COMPLEX

(71) Applicants: Elkem Silicones France SAS, Lyon (FR); Centre National de la Recherche Scientifique (CNRS), Paris (FR); Universite Claude Bernard Lyon 1, Villeurbanne (FR); CPE Lyon, Villeurbanne (FR)

(72) Inventors: Raphael MIRGALET, Lyon (FR); Anthony VIVIEN, Villeurbanne (FR); Clément CAMP, Lyon (FR); Laurent VEYRE, Jardin (FR); Chloé THIEULEUX, Villeurbanne (FR)

(21) Appl. No.: 19/145,280

(22) PCT Filed: Jan. 4, 2024
(86) PCT No.: PCT/FR2024/000001

§ 371 Date: Jul. 2, 2025

(30) Foreign Application Priority Data
Jan. 6, 2023 (FR) FR2300169
Jun. 20, 2023 (FR) FR2306350

(51) Int. Cl. C07F 7/08; B01J 31/20

(52) U.S. Cl. CPC C07F 7/0879; B01J 31/20

(57) ABSTRACT

The present invention relates to hydrosilylation reactions between a monosubstituted alkene compound and a compound comprising at least one hydrogen atom bonded to a silicon atom. More specifically, the invention relates to a process for hydrosilylation of an unsaturated compound A comprising at least one monosubstituted alkene function with a compound B comprising at least one hydrosilyl function, catalysed by a manganese complex C having the oxidation state I, in the presence of air and/or water. This hydrosilylation reaction between an alkene compound and a compound comprising at least one hydrogen atom bonded to a silicon atom makes it possible in particular to crosslink silicone compositions.

### TECHNICAL FIELD

The present invention relates to the hydrosilylation reactions between a monosubstituted alkene compound and a compound comprising at least one hydrogen atom bonded to a silicon atom. More specifically, the invention relates to a hydrosilylation process catalyzed by a manganese complex. This hydrosilylation reaction between an alkene compound and a compound comprising at least one hydrogen atom bonded to a silicon atom in particular enables the crosslinking of silicone compositions.

### PRIOR ART

During a reaction for the hydrosilylation of alkene compounds (also known as polyaddition), a compound comprising at least one double bond reacts with a compound comprising at least one hydrosilyl function, i.e. a hydrogen atom bonded to a silicon atom. This reaction can for example be described by:

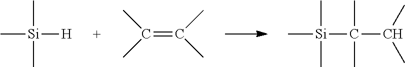

The hydrosilylation reaction can be accompanied by, or even sometimes replaced by, a dehydrogenating silylation (also referred to as dehydrosilylation) reaction. The reaction can be described by:

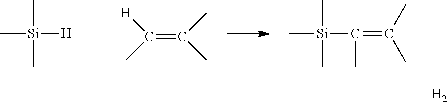

The hydrosilylation reaction is used in particular to crosslink silicone compositions comprising organopolysiloxanes bearing alkenyl units and organopolysiloxanes comprising hydrosilyl functions.

The reaction for the hydrosilylation of alkene compounds is typically performed by catalysis, using metallic or organometallic catalysts. Currently, the catalyst that is suitable for this reaction is a platinum catalyst. Thus, the majority of the industrial hydrosilylation processes, in particular of alkenes, are catalyzed by Speier's hexachloroplatinic acid or by Karstedt's Pt(0) complex, of general formula Pt₂ (divinyltetramethyldisiloxane)₃ (abbreviated as Pt₂(DVTMS)₃).

In the early 2000s, the preparation of platinum-carbene complexes made it possible to access more stable catalysts (see, for example, patent application WO 01/42258).

However, the use of platinum metallic or organometallic catalysts is still problematic. It is an expensive metal that is becoming harder to find, and the price of which fluctuates enormously. It is therefore difficult to use on the industrial scale. It is thus desired to minimize the amount of catalyst required for the reaction, without, however, reducing the yield or the reaction rate. Numerous studies have been carried out to find alternatives to Karstedt's catalyst.

In the last ten years, the use of homogeneous manganese-based catalysts in organic synthesis has been described as a possible alternative. The scientific article by Antonio Torres-Calis and Juventino J. Garci entitled “Homogeneous Manganese-Catalyzed Hydrofunctionalizations of Alkenes and Alkynes: Catalytic and Mechanistic Tendencies” (ACS Omega 2022, 7, 37008-37038) provides an exhaustive review of the manganese-based catalytic systems proposed for the hydrosilylation of alkenes. The scientific article by Dong et al, “Manganese-catalysed divergent silylation of alkenes” (Nature Chemistry, vol. 13, February 2021, 182-190) describes a manganese-based catalyst for the dehydrosilylation and hydrosilylation of alkenes. Mn₂(CO)₁₀ is used as a metal precursor and must be combined with a ligand, preferably a JackiePhos ligand to favor the hydrosilylation reaction. In the Mn₂(CO)₁₀ complex, the manganese is in the oxidation state of 0.

Yang X. and Wang C. (“Diverse Fates of β-silyl Radical under Manganese Catalysis: Hydrosilylation and Dehydrogenative Silylation of Alkenes”, Chin. J. Chem. 2018, 36, 1047-1051) described the chemoselective and regioselective hydrosilylation of alkenes catalyzed by the MnBr(CO)₅ complex. The authors demonstrated the radical nature of the reaction mechanism. The hydrosilylation process was carried out under an inert atmosphere, in the absence of air and water. All the examples were carried out under an inert atmosphere in dry Schlenk tubes. The solvents were purified by distillation over sodium and stored under nitrogen.

More recently, a scientific article (Anthony Vivien, Laurent Veyre, Raphael Mirgalet, Clément Camp, Chloé Thieuleux, “Mn₂(CO)₁₀ and UV light: a promising combination for regioselective alkene hydrosilylation at low temperature”, Chem. Commun., 2022, 58, 4091-4094) described the use of another manganese-based catalyst: dimanganese decacarbonyl, of chemical formula [Mn₂(CO)₁₀]. Advantageously, this is a commercial product that is inexpensive and stable in air. However, the hydrosilylation reaction is itself always carried out under an inert atmosphere, in dry flasks under argon. The reagents and solvents were purified and stored under argon in glove boxes.

Due to the radical mechanism of the reaction, there is a technical preconception according to which the catalysts described in the prior art must be used under anhydrous conditions, in the absence of air and water. Furthermore, the other reagents and any solvents must be purified and dried before use. From an industrial point of view, it is difficult and expensive to comply with such conditions. It is within this context that the inventors sought a more efficient process for the hydrosilylation of alkene compounds. Advantageously, it is desired to overcome the constraints related to the sensitivity of the reaction to air and moisture. Furthermore, it is desired for the hydrosilylation reaction to be rapid, at moderate temperature, and selective, in particular for the dehydrosilylation and/or isomerization reactions of the alkene compound to be reduced or even negligible. Finally, it is desired for the catalyst to contain an abundant, inexpensive and non-toxic chemical element.

### SUMMARY OF THE INVENTION

Against all expectations, the inventors discovered that catalysts based on manganese in the I oxidation state could advantageously be used in the presence of water and air. The inventors discovered that the reaction for hydrosilylation of monosubstituted alkenes could be catalyzed by complexes of manganese in the I oxidation state, with excellent yields and an excellent selectivity, under conditions similar to industrial conditions, in air and with unpurified reagents.

The present invention relates to a process for the hydrosilylation of an unsaturated compound A comprising at least one monosubstituted alkene function, with a compound B comprising at least one hydrosilyl function, catalyzed by a complex of manganese in the I oxidation state C, in the presence of air and/or water.

### BRIEF DESCRIPTION OF THE FIGURES

FIG. 1 illustrates comparative example 1.

### DETAILED DESCRIPTION OF THE INVENTION

Unless otherwise indicated, all the viscosities of the silicone oils with which the present document is concerned correspond to a “Newtonian” dynamic viscosity quantity at 25° C., i.e. the dynamic viscosity that is measured, in a manner known per se, with a Brookfield viscometer at a shear rate gradient that is low enough for the viscosity measured to be independent of the rate gradient.

Although not denoted, the possible tautomeric forms of the compounds described in the present account are included within the scope of the present invention.

In the present invention, an alkyl group may be linear or branched. An alkyl group preferably comprises between 1 and 30 carbon atoms, more preferentially between 1 and 12 carbon atoms, even more preferentially between 1 and 6 carbon atoms. An alkyl group may for example be chosen from the following groups: methyl, ethyl, n-propyl, isopropyl, n-butyl, isobutyl, s-butyl, t-butyl, n-pentyl, n-hexyl, n-heptyl, n-octyl, n-nonyl, n-decyl, n-undecyl and n-dodecyl.

In the present invention, a cycloalkyl group may be monocyclic or polycyclic, preferably monocyclic or bicyclic. A cycloalkyl group preferably comprises between 3 and 30 carbon atoms, more preferentially between 3 and 8 carbon atoms. A cycloalkyl group may be chosen from the following groups: cyclopropyl, cyclobutyl, cyclopentyl, cyclohexyl, cycloheptyl, cyclooctyl, adamantane and norborane.

In the present invention, an aryl group may be monocyclic or polycyclic, preferably monocyclic, and preferably comprises between 6 and 30 carbon atoms, more preferentially between 6 and 18 carbon atoms. An aryl group may be unsubstituted or be substituted one or more times by an alkyl group. The aryl group may be chosen from phenyl, naphthyl, anthracenyl, phenanthryl, mesityl, tolyl, xylyl, diisoproylphenyl and triisopropylphenyl groups.

In the present invention, an arylalkyl group preferably comprises between 6 and 30 carbon atoms, more preferentially between 7 and 20 carbon atoms. An arylalkyl group may for example be chosen from the following groups: benzyl, phenylethyl, phenylpropyl, naphthylmethyl, naphthylethyl and naphthylpropyl.

In the present invention, the halogen atom may for example be selected from the group consisting of fluorine, bromine, chlorine and iodine, fluorine being preferred. A fluorine-substituted alkyl group may for example be trifluoropropyl.

The present invention uses a catalyst C consisting of a manganese (I) complex, that is to say in the I oxidation state. Advantageously, manganese is an abundant natural element and is generally considered to be non-toxic within the limit of the doses which make it a trace element. In the present invention, the manganese (I) complex is a metal complex consisting of one or more manganese atoms in the I oxidation state and ligands bonded to the manganese.

The manganese (I) complex according to the invention can be a metal complex consisting of one or more manganese atoms in the I oxidation state, carbonyl ligands, and an X-type ligand bonded to the manganese. By definition, an X-type ligand provides only one electron to the coordination sphere of the metal to which it is bound.

According to one embodiment, the manganese (I) complex may be chosen from complexes of formula Mn(CO)₅Z, in which Z represents a coordinating or non-coordinating anion. Z can for example be selected from the group consisting of: H⁻, F⁻, Cl⁻, Br⁻, I⁻, OH⁻, BF₄⁻, PF₆⁻, NO₃⁻, ClO₄⁻, RCOO⁻, CF₃COO⁻, RSO₃⁻, BH₄⁻, BR₄⁻, AlR₄⁻, Al(OR)₄⁻, NH₂⁻, RO⁻, CN⁻, R₂N⁻, SCN⁻, OCN⁻, OCP⁻, RS⁻, R⁻CONH⁻, (R—CO)₂N⁻, HCO₃⁻, HSO₄⁻, H₂PO₄⁻, acetylacetonate, pentafluorobenzoate, bis(trimethylsilyl)amide, tetrakis[pentafluorophenyl] borate and tetrakis [3,5-bis(trifluoromethyl)phenyl]borate, R representing a C₁₋₁₀ alkyl group, CF₃, C₂F₅, C(CF₃)₃, a C₃₋₁₀ cycloalkyl group, a C₃₋₁₀ heterocyclic group comprising at least one N, O or S heteroatom, a C₅₋₁₀ aryl group, or a C₅₋₁₀ heteroaryl group comprising at least one N, O or S heteroatom.

Very preferably, the manganese (I) complex is specifically manganese (I) bromopentacarbonyl, of chemical formula [MnBr(CO)₅] (CAS number: 14516-54-2). Advantageously, it is a commercial product that is inexpensive and stable in air.

The catalyst C according to the invention is advantageously used without an organic ligand, in particular:
without a nitrogen-based ligand, such as for example a pyridine ligand, and/or
without a phosphorus-based ligand, such as for example a phosphine ligand, and/or
without an acyl ligand, and/or
without a diketone ligand, such as for example a β-diketone ligand, and/or
without a substituted or unsubstituted cyclopentadienyl ligand, and/or
without an organometallic ligand, such as triphenylarsine.

The molar concentration of catalyst C may be from 0.01 mol % to 15 mol %, more preferentially from 0.05 mol % to 10 mol %, more preferentially from 0.1 mol % to 5 mol %, even more preferentially from 0.2 mol % to 2 mol %, relative to the total number of moles of unsaturations borne by the unsaturated compound A.

According to a preferred variant, in the process according to the invention, compounds based on platinum, palladium, ruthenium or rhodium are not used. The amount of compounds based on platinum, palladium, ruthenium or rhodium in the reaction medium is, for example, less than 0.1% by weight relative to the weight of catalyst C, preferably less than 0.01% by weight and more preferentially less than 0.001% by weight.

In the hydrosilylation process according to the present invention, the unsaturated compound A used comprises at least one monosubstituted alkene function. Said monosubstituted alkene unsaturation is not part of an aromatic ring. The unsaturated compound A may be chosen from those known to a person skilled in the art and which do not contain a reactive chemical function that may interfere with, or even prevent, the hydrosilylation reaction.

In the present text, a “monosubstituted alkene” or “monosubstituted alkenyl” means a covalent double bond between two carbon atoms, which is not part of an aromatic ring, the two carbon atoms being bonded to 3 hydrogen atoms and a monovalent radical other than a hydrogen atom. The unsaturated compound A used in the hydrosilylation process according to the invention can be represented by the general formula (1):

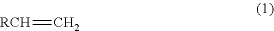

in which R represents a monovalent radical.

According to one embodiment, the unsaturated compound A comprises one or more monosubstituted alkene functions and from 2 to 40 carbon atoms. The unsaturated compound A may be represented by the general formula (1):

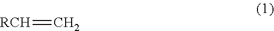

wherein R represents a monovalent radical selected from the group consisting of:
an alkyl group having between 1 and 30 carbon atoms, more preferentially between 1 and 12 carbon atoms, even more preferentially between 1 and 6 carbon atoms, optionally substituted with one or more halogen atoms such as chlorine or fluorine, and optionally with one or more groups selected from —OH and —OSiR′₃, wherein each R′ represents, independently of one another, H or an alkyl group;
an aryl group having between 6 and 30 carbon atoms, more preferentially between 6 and 18 carbon atoms, optionally substituted with one or more halogen atoms such as chlorine or fluorine, and optionally with one or more groups selected from alkyl groups, haloalkyl groups, —OH and —OR′ and —OSiR′3, wherein each R′ represents, independently of one another, H or an alkyl group;
an aryl-alkyl group preferably comprises between 6 and 30 carbon atoms, more preferentially between 7 and 20 carbon atoms, optionally substituted on the aryl part thereof and/or on the alkyl part thereof, with one or more halogen atoms such as chlorine or fluorine, and optionally with one or more groups selected from alkyl groups, haloalkyl groups, —OH and —OR′ and OSiR′₃, wherein each R′ represents, independently of one another, H or an alkyl group;
an ether group of formula —L—O—R″, wherein L represents a bond or a divalent radical, preferably an alkylene group having from 1 to 12 carbon atoms, even more preferentially between 1 and 6 carbon atoms, and R″ represents a group selected from: an alkyl group having between 1 and 30 carbon atoms, more preferentially between 1 and 12 carbon atoms, even more preferentially between 1 and 6 carbon atoms, optionally substituted with one or more halogen atoms such as chlorine or fluorine, and optionally with one or more groups selected from —OH and —OSiR′3, wherein each R′ represents, independently of one another, H or an alkyl group; an aryl group having between 6 and 30 carbon atoms, more preferentially between 6 and 18 carbon atoms, optionally substituted with one or more halogen atoms such as chlorine or fluorine, and optionally with one or more groups chosen from alkyl groups, haloalkyl groups, —OH, —OR′ and —OSiR′3, wherein each R′ represents, independently of one another, H or an alkyl group; and an aryl-alkyl group preferably comprises between 6 and 30 carbon atoms, more preferentially between 7 and 20 carbon atoms, optionally substituted on the aryl part thereof and/or on the alkyl part thereof, with one or more halogen atoms such as chlorine or fluorine, and optionally with one or more groups selected from alkyl groups, haloalkyl groups, —OH, —OR′ and —OSiR′3, wherein each R′ represents, independently of one another, H or an alkyl group;
an ester group of formula —L—C(O)—O—R″ or —L—O—C(O)—R″, wherein L and R″ have the same definitions as those given above.

The unsaturated compound A may preferably be an organic compound comprising a monosubstituted alkene group selected from the group consisting of:
α-olefins, preferably 1-octene and 1-hexene,
chlorinated α-olefins, preferably allyl chloride,
fluorinated α-olefins, preferably 4,4,5,5,6,6,7,7,7-nonafluoro-1-heptene,
allyl alcohol,
allyl ethers, such as allyl benzyl ether, allyl phenyl ether, allyl C₁-C₈ alkyl ethers, allyl glycidyl ether, allyl ether of piperidine, preferentially allyl ether of sterically hindered piperidine, allyl silyl ethers, preferentially allyl trimethylsilyl ether,
aliphatic alkenoic acid esters, such as C₁ to C₄ alkyl acrylates,
acrylic acid,
allyl esters, such as allyl acetate,
styrenes, allylbenzenes and phenyl α-olefins,
1,2-epoxy-4-vinylcyclohexane.

The unsaturated compound A may be a disiloxane, such as vinylpentamethyldisiloxane and divinyltetramethyldisiloxane.

The unsaturated compound A may be selected from compounds comprising several monosubstituted alkene functions, preferably two or three monosubstituted alkene functions, and particularly preferably the compound A is selected from the following compounds:

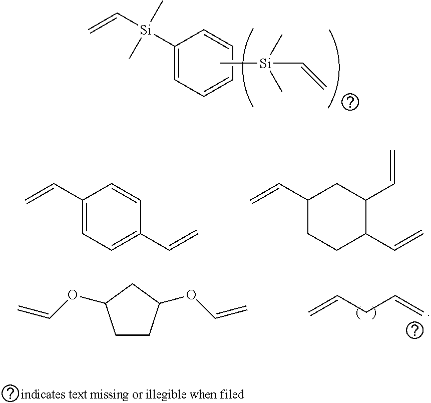

According to a particularly preferred embodiment, the unsaturated compound A may be an organopolysiloxane compound comprising one or more monosubstituted alkene functions, preferably at least two monosubstituted alkene functions. The reaction for hydrosilylation of alkenes is one of the key reactions in silicone chemistry. It enables not only the crosslinking between organopolysiloxanes containing SiH functions and organopolysiloxanes containing alkenyl functions in order to form networks and impart mechanical properties to the materials, but also the functionalization of organopolysiloxanes containing SiH functions in order to modify the physical and chemical properties thereof.

Said organopolysiloxane compound may be formed in particular from:
at least two siloxyl units of the formula below: YₐR_{b}¹SiO_{(4-a-b)/2}
   wherein:
Y is a C₂ to C₁₂ monosubstituted alkenyl group, preferably a vinyl group,
R¹ is a monovalent hydrocarbon group having from 1 to 12 carbon atoms, preferably selected from alkyl groups having from 1 to 8 carbon atoms, such as methyl, ethyl and propyl groups, cycloalkyl groups having from 3 to 8 carbon atoms and aryl groups having from 6 to 12 carbon atoms, and
a=1, 2 or 3, preferably a=1 or 2, more preferentially a=1; b=0, 1 or 2; and the sum a+b=1, 2 or 3; and
optionally from units having the formula below: R_{c}¹SiO_{(4-c)/2}
wherein R¹ has the same meaning as above and c=0, 1, 2 or 3.

It is understood in formulae above that, if several R′groups are present or if several Y groups are present, they may be identical to or different from one another. Preferentially, R¹ can represent a monovalent radical selected from the group consisting of alkyl groups having from 1 to 8 carbon atoms, optionally substituted with at least one halogen atom, such as chlorine or fluorine, cycloalkyl groups having from 3 to 8 carbon atoms and aryl groups having from 6 to 12 carbon atoms. R¹ can advantageously be chosen from the group consisting of methyl, ethyl, propyl, 3,3,3-trifluoropropyl, xylyl, tolyl and phenyl.

These organopolysiloxane compounds comprising one or more monosubstituted alkene functions may have a linear structure, a cyclic structure or a branched structure.

In the following section concerning the description of the unsaturated organopolysiloxane, the following nomenclature has been used to represent the siloxyl units:
an “M^{Vi}” siloxyl unit represents a siloxyl unit of formula YR₂¹SiO_{1/2} or Y₂R¹SiO_{1/2},
an “M” siloxyl unit represents a siloxyl unit of formula R₃¹SiO_{1/2},
a “D^{Vi}” siloxyl unit represents a siloxyl unit of formula YR¹SiO_{2/2},
a “D” siloxyl unit represents a siloxyl unit of formula R₂¹SiO_{2/2},
a “T” siloxyl unit represents a siloxyl unit of formula R¹SiO_{3/2},
a “Q” siloxyl unit represents a siloxyl unit of formula SiO_{4/2},
the symbols Y and R¹ being as described above.

As examples of terminal “M” and “M^{Vi}” siloxyl units, mention may be made of trimethylsiloxy, dimethylphenylsiloxy, dimethylvinylsiloxy or dimethylhexenylsiloxy groups.

As examples of “D” and “D^{Vi}” siloxyl units, mention may be made of dimethylsiloxy, methylphenylsiloxy, methylvinylsiloxy, methylbutenylsiloxy, methylhexenyl-siloxy, methyldecenylsiloxy or methyldecadienylsiloxy groups.

The linear organopolysiloxane compounds comprising one or more monosubstituted alkene functions essentially consist of “D” and “D^{Vi}” siloxyl units and of “M” and “M^{Vi}” siloxyl units. Examples of linear organopolysiloxanes which may be organopolysiloxane compounds comprising one or more monosubstituted alkene functions according to the invention are:
a dimethylvinylsilyl-terminated poly(dimethylsiloxane);
a dimethylvinylsilyl-terminated poly(dimethylsiloxane-co-methylphenylsiloxane);
a dimethylvinylsilyl-terminated poly(dimethylsiloxane-co-methylvinylsiloxane); and
a trimethylsilyl-terminated poly(dimethylsiloxane-co-methylvinylsiloxane).

In the most recommended form, the organopolysiloxane compound comprising one or more monosubstituted alkene functions contains terminal dimethylvinylsilyl units. Even more preferentially, the organopolysiloxane compound comprising one or more monosubstituted alkene functions is a dimethylvinylsilylp-terminated poly(dimethylsiloxane).

A silicone oil generally has a viscosity of between 1 mPa·s and 2,000,000 mPa·s. Preferably, said organopolysiloxane compounds comprising one or more alkene functions are silicone oils with a dynamic viscosity of between 20 mPa·s and 100,000 mPa·s, preferably between 20 mPa·s and 80,000 mPa·s at 25° C., and more preferentially between 100 mPa·s and 50,000 mPa·s.

The cyclic organopolysiloxane compounds comprising one or more monosubstituted alkene functions essentially consist of “D” and “D^{Vi}” siloxyl units as described above. An example of a cyclic organopolysiloxane which may be an organopolysiloxane compound comprising one or more monosubstituted alkene functions according to the invention is cyclic poly(methylvinylsiloxane).

Optionally, the organopolysiloxane compounds comprising one or more monosubstituted alkene functions may also contain “T” siloxyl units and/or “Q” siloxyl units. The organopolysiloxane compounds comprising one or more monosubstituted alkene functions then have a branched structure. Examples of branched organopolysiloxanes, also referred to as resins, which may be organopolysiloxane compounds comprising one or more monosubstituted alkene functions according to the invention are:
MD^{Vi}Q, where the vinyl groups are included in the D units,
MD^{Vi}TQ, where the vinyl groups are included in the D units,
MM^{Vi}Q, where the vinyl groups are included in a portion of the M units,
MM^{Vi}TQ, where the vinyl groups are included in a portion of the M units,
MM^{Vi}DD^{Vi}Q, where the vinyl groups are included in a portion of the M and D units,
and mixtures thereof.

Preferably, the organopolysiloxane compound comprising one or more monosubstituted alkene functions has a weight content of monosubstituted alkenyl units of between 0.001% and 30%, preferably between 0.01% and 10%, preferably between 0.02% and 5%.

The unsaturated compound A reacts according to the present invention with a compound B comprising at least one hydrosilyl function.

According to one embodiment, the compound B comprising at least one hydrosilyl function is a silane or polysilane compound comprising at least one hydrogen atom bonded to a silicon atom. A “silane” compound is understood in the present invention to mean chemical compounds comprising a silicon atom bonded to four hydrogen atoms or to organic substituents. In the present invention, “polysilane” compound is understood to mean chemical compounds having at least one ≡Si—Si≡ unit. Among the silane compounds, the compound B comprising at least one hydrosilyl function may be a mono-, di- or tri-alkylsilane or a mono-, di- or tri-arylsilane, for example triethylsilane, phenyldimethylsilane, benzyldimethylsilane and diphenylsilane.

According to another embodiment, the compound B comprising at least one hydrosilyl function is an organopolysiloxane compound comprising at least one hydrogen atom bonded to a silicon atom, also known as organohydropolysiloxane. Said organohydropolysiloxane may advantageously be an organopolysiloxane formed of:
at least two siloxyl units of the following formula: H_{d}Rₑ²SiO_{(4-d-e)/2} wherein:
R² is a monovalent hydrocarbon group having from 1 to 12 carbon atoms, preferably chosen from alkyl groups having from 1 to 8 carbon atoms, such as methyl, ethyl or propyl groups, cycloalkyl groups having from 3 to 8 carbon atoms and aryl groups having from 6 to 12 carbon atoms, and
d=1, 2 or 3, preferably d=1 or 2, more preferentially d=1; e=0, 1 or 2; and d+e=1, 2 or 3; and
optionally other units of the following formula: R_{f}²SiO_{(4-f)/2}
wherein R² has the same meaning as above and f=0, 1, 2 or 3.

It is understood in the above formulae that, if several R² groups are present, they may be identical to or different from one another. Preferentially, R² may represent a monovalent radical selected from the group consisting of alkyl groups having 1 to 8 carbon atoms, optionally substituted by at least one halogen atom such as chlorine or fluorine, cycloalkyl groups having from 3 to 8 carbon atoms and aryl groups having from 6 to 12 carbon atoms. R² can advantageously be chosen from the group consisting of methyl, ethyl, propyl, 3,3,3-trifluoropropyl, xylyl, tolyl and phenyl.

The organohydropolysiloxane may have a linear, branched or cyclic structure. The degree of polymerization is preferably greater than or equal to 2. Generally, it is less than 5000.

In the following section concerning the description of the organohydropolysiloxane, the following nomenclature has been used to represent the siloxyl units:
an “M” siloxyl unit represents a siloxyl unit of formula R₃²SiO_{1/2},
an “M′” siloxyl unit represents a siloxyl unit of formula HR₂²SiO_{1/2},
a “D” siloxyl unit represents a siloxyl unit of formula R₂²SiO_{2/2},
a “D′” siloxyl unit represents a siloxyl unit of formula HR²SiO_{2/2},
a “T” siloxyl unit represents a siloxyl unit of formula R²SiO_{3/2},
a “Q” siloxyl unit represents a siloxyl unit of formula SiO_{4/2},
the symbol R¹ being as described above.

When it is a question of linear polymers, these essentially consist of siloxyl units chosen from the “D” and “D′” siloxyl units, and terminal “M” and “M′” siloxyl units. Examples of organohydropolysiloxanes which may be compounds B comprising at least one hydrosilyl function according to the invention are:
a hydrodimethylsilyl-terminated poly(dimethylsiloxane);
a trimethylsilyl-terminated poly(dimethylsiloxane-co-methylhydrosiloxane);
a hydrodimethylsilyl-terminated poly(dimethylsiloxane-co-methylhydrosiloxane); and
a trimethylsilyl-terminated poly(methylhydrosiloxane).

When the organohydrogenpolysiloxane has a cyclic structure, it essentially consists of siloxyl units chosen from the “D” and “D′” siloxyl units. An example of a cyclic organohydropolysiloxane which may be a compound B comprising at least one hydrosilyl function according to the invention is a cyclic poly(methylhydrosiloxane).

When the organohydropolysiloxane has a branched structure, it is preferably selected from the group consisting of silicone resins of the following formulae:
M′Q where the hydrogen atoms bonded to silicon atoms are borne by the M groups,
MM′Q where the hydrogen atoms bonded to silicon atoms are borne by a portion of the M units,
MD′Q where the hydrogen atoms bonded to silicon atoms are borne by the D groups,
MDD′Q where the hydrogen atoms bonded to silicon atoms are borne by a portion of the D groups,
MM′TQ where the hydrogen atoms bonded to silicon atoms are borne by a portion of the M units,
MM′DD′Q where the hydrogen atoms bonded to silicon atoms are borne by a portion of the M and D units,
and mixtures thereof.

Preferably, the organohydropolysiloxane compound has a weight content of Si—H hydrosilyl functions of between 0.2% and 91%, more preferentially between 3% and 80%, and even more preferentially between 15% and 70%.

The amounts of compound A and compound B can be controlled so that the molar ratio of the hydrosilyl functions of compounds B to the monosubstituted alkene functions of compounds A is preferably included between 1:10 and 10:1, more preferably between 1:5 and 5:1, more preferably between 1:3 and 3:1, and even more preferably between 1:2 and 2:1.

According to a particular embodiment of the present invention, it is possible for the unsaturated compound A and compound B comprising at least one hydrosilyl function to be one and the same compound, comprising firstly at least one monosubstituted alkene function, and secondly at least one silicon atom and at least one hydrogen atom bonded to the silicon atom. This compound may then be described as “bifunctional”, and it is capable of reacting with itself via a hydrosilylation reaction. The invention may therefore also relate to a process for the hydrosilylation of a bifunctional compound with itself, said bifunctional compound comprising firstly at least one monosubstituted alkene function, and secondly at least one silicon atom and at least one hydrogen atom bonded to the silicon atom, said process being catalyzed by the catalyst C as described above.

Examples of organopolysiloxanes which may be bifunctional compounds are:
a dimethylvinylsilyl-terminated poly(dimethylsiloxane-co-hydromethylsiloxane-co-vinylmethylsiloxane);
a dimethylhydrosilyl-terminated poly(dimethylsiloxane-co-hydromethylsiloxane-co-vinylmethylsiloxane); and
a trimethylsilyl-terminated poly(dimethylsiloxane-co-hydromethylsiloxane-co-propyl glycidyl ether methylsiloxane).

When it is a question of the use of the unsaturated compound A and the compound B comprising at least one hydrosilyl function, a person skilled in the art understands that this also means the use of a bifunctional compound.

The process according to the present invention is characterized in particular by the fact that the hydrosilylation reaction is carried out in the presence of air and/or water. Specifically, it was discovered very surprisingly that the reaction was insensitive to air and moisture.

The hydrosilylation process according to the invention is preferably carried out in air; it is not carried out under an inert atmosphere, in particular it is not carried out under nitrogen, under argon or under oxygen-depleted air.

The hydrosilylation reaction may be performed at a temperature of between 15° C. and 300° C., preferentially between 20° C. and 240° C., more preferentially between 50° C. and 200° C., more preferentially between 50° C. and 140° C., and even more preferentially between 50° C. and 100° C.

The hydrosilylation reaction may be performed in a solvent or in the absence of solvent. Suitable solvents are solvents miscible with compound B. For example, the solvent may be chosen from the group consisting of aliphatic hydrocarbons, such as pentane, hexane, heptane, cyclohexane, decalin, and liquid paraffins; aromatic hydrocarbons, such as toluene, and xylene; mixtures of hydrocarbons of mineral or synthetic origin, such as white spirit; ethers, such as tetrahydrofuran, dioxane, diethyl ether, diphenyl ether and anisole; chlorinated hydrocarbons, such as methylene chloride, 1,2-dichloroethane, perchloroethylene and chlorobenzene; esters, such as ethyl acetate, butyl acetate and butyrolactone; acetonitrile; dimethylformamide; dimethyl sulfoxide; N-methylpyrrolidone; polyethylene glycols; water; and mixtures thereof. Preferably, the solvent may be chosen from the group consisting of aliphatic hydrocarbons, aromatic hydrocarbons and chlorinated hydrocarbons, and more preferentially from the group consisting of hexane, cyclohexane, decalin and toluene.

As a variant, the solvent may be chosen from volatile silicones, octamethylcyclotetrasiloxane (D4), decamethylcylopentasiloxane (D5), polydimethylsiloxane (PDMS) oils, polyphenylmethylsiloxane (PPMS) oils or mixtures thereof. As a variant, one of the reagents, for example the unsaturated compound A, may act as solvent. Preferably, the use of organic solvents that are harmful to the environment and to the health of workers in manufacturing plants will be avoided.

According to another variant, the solvent can be chosen from the most environmentally-friendly solvents. For example, reference may be made to the scientific publications by Alder et al. (Green Chem., 2016, 18, 3879) or by Prat et al. (Green Chem., 2016, 18, 288). Preferably, the solvent may be chosen from the group consisting of water, anisole and ethyl acetate, more preferably water and anisole.

When it is present, the amount of solvent can be adjusted by a person skilled in the art to ensure good miscibility of the reagents. For example, the volume of solvent may be between 5% and 70%, preferably between 10% and 50%, of the total volume of the reaction medium.

Advantageously, the reagents and solvents used in the process according to the invention can be used without a prior purification step. Surprisingly, it has been observed that the performance of the hydrosilylation reaction obtained with unpurified reagents was equivalent to that obtained with purified reagents.

The discovery of this new hydrosilylation process according to the present invention makes it possible to envisage numerous applications.

When the compounds A and B used are chosen from organopolysiloxanes as defined above, the hydrosilylation reaction makes it possible to form a three-dimensional network, which leads to curing or crosslinking of the composition. The crosslinking involves a gradual physical change in the medium constituting the composition. Consequently, the process according to the invention can be used to obtain elastomers, gels, foams, etc. In this case, a crosslinked silicone material is obtained. A “crosslinked silicone material” is understood to mean any silicone-based product obtained by crosslinking and/or curing of compositions comprising organopolysiloxanes having at least two unsaturated bonds and organopolysiloxanes having at least three hydrosilyl units. The crosslinked silicone material may be, for example, an elastomer, a gel or a foam.

Still according to this preferred embodiment of the process according to the invention, where the compounds A and B are chosen from the organopolysiloxanes as defined above, use may be made of functional additives that are customary in silicone compositions. As families of usual functional additives, mention may be made of:
fillers,
adhesion promoters,
inhibitors or retarders of the hydrosilylation reaction,
adhesion modifiers,
silicone resins,
consistency-enhancing additives,
pigments (organic or mineral pigments), and
heat-resistant, oil-resistant or fire-resistant additives, for example metal oxides.

The filler optionally provided is preferably a mineral filler. The filler may be a very finely divided product, the mean particle diameter of which is less than 0.1 μm. The filler may in particular be a siliceous filler. As regards the siliceous materials, they can act as a reinforcing or semi-reinforcing filler. The reinforcing siliceous fillers are chosen from colloidal silicas, powders of fumed silica and of precipitated silica, or their mixtures. These powders have a mean particle size of generally less than 0.1 μm (micrometers) and a BET specific surface area of greater than 30 m²/g, preferably between 30 and 350 m²/g. Semi-reinforcing siliceous fillers, such as diatomaceous earths or ground quartz, can also be used. These silicas may be incorporated in unmodified form or after having been treated with organosilicon compounds usually used for this purpose. Among these compounds are methylpolysiloxanes such as hexamethyldisiloxane, octamethylcyclotetrasiloxane, methylpolysilazanes such as hexamethyldisilazane, hexamethylcyclotrisilazane, tetramethyldivinyldisilazane, chlorosilanes such as dimethyldichlorosilane, trimethylchlorosilane, methylvinyldichlorosilane, dimethylvinylchlorosilane, alkoxysilanes such as dimethyldimethoxysilane, dimethylvinylethoxysilane, trimethylmethoxysilane, and mixtures thereof. As regards the nonsiliceous inorganic materials, they can be involved as semi-reinforcing or bulking inorganic filler. Examples of these non-siliceous fillers that can be used alone or as a mixture are calcium carbonate, optionally surface-treated with an organic acid or with an organic acid ester, calcined clay, titanium oxide of rutile type, iron oxide, zinc oxide, chromium oxide, zirconium oxide, magnesium oxide, the various forms of alumina (hydrated or non-hydrated), boron nitride, lithopone, barium metaborate, barium sulfate and glass microbeads. These fillers are coarser with a mean particle diameter generally of greater than 0.1 μm and a specific surface area generally of less than 30 m²/g. These fillers may have been surface-modified by treatment with the various organosilicon compounds customarily employed for this purpose. Preferably, the filler is silica, and even more preferentially fumed silica. Advantageously, the silica has a BET specific surface area of between 75 m²/g and 410 m²/g. A silicone composition may comprise between 5% and 20% by weight of filler relative to the total weight of the silicone composition. Advantageously, the silicone composition may comprise between 8% and 15% by weight of filler.

According to a particularly preferred embodiment, the hydrosilylation process according to the present invention can be used for crosslinking between organopolysiloxanes containing SiH functions and organopolysiloxanes containing alkenyl functions, to form networks and to impart mechanical properties to the materials. According to this embodiment, the unsaturated compound A comprising at least one monosubstituted alkene function is an organopolysiloxane compound comprising at least two monosubstituted alkene functions, and compound B comprising at least one hydrosilyl function is an organopolysiloxane compound comprising at least three hydrogen atoms bonded to a silicon atom. A process for the preparation of crosslinked silicone materials can be described, characterized in that the crosslinking reaction between organopolysiloxanes containing SiH functions and organopolysiloxanes containing alkenyl functions is obtained by the hydrosilylation process as described above. The resulting crosslinked silicone materials can be used in various applications, notably:
“coating” applications, where a support is covered with a silicone coating;
applications in the electronics field, for example for the preparation of conformal coatings for printed circuits, and for the potting of microcircuits and electronic components such as IGBTs;
additive manufacturing processes (also known as 3D printing processes).

According to another embodiment, the hydrosilylation process according to the present invention can be used for the functionalization of organopolysiloxanes containing SiH functions. Functionalization aims to modify the physical and/or chemical properties of said organopolysiloxanes, and to produce new compounds with improved properties. According to this embodiment, the unsaturated compound A comprising at least one monosubstituted alkene function is chosen from unsaturated compounds comprising one or more monosubstituted alkene functions and from 2 to 40 carbon atoms, and compound B comprising at least one hydrosilyl function is an organopolysiloxane compound comprising at least one hydrogen atom bonded to a silicon atom. A process for functionalizing organopolysiloxanes containing SiH functions can be described, characterized in that the addition reaction between organopolysiloxanes containing SiH functions and unsaturated compounds A comprising one or more monosubstituted alkene functions and from 2 to 40 carbon atoms is obtained by the hydrosilylation process as described above.

Other details or advantages of the invention will become more clearly apparent in light of the examples given below solely by way of indication.

### EXAMPLES

### Comparative Example 1

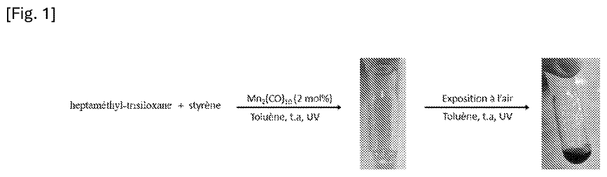

The catalysts described in the prior art must be used under anhydrous conditions, in the absence of air and water. The sensitivity of Mn₂(CO)₁₀ to air was demonstrated in the following comparative example 1, illustrated in FIG. 1:

Styrene and 1,1,1,3,5,5,5-heptamethyltrisiloxane were introduced into a vial under an argon atmosphere at room temperature. A solution of dimanganese decacarbonyl Mn₂(CO)₁₀ in toluene was injected into the vial and toluene was added. Final concentration of Mn₂(CO)₁₀ (relative to styrene)=2 mol %.

Initially, the reaction mixture was placed under UV light for 30 min at room temperature. The reaction medium is clear pale yellow. At 30 minutes, the reaction medium was exposed to air. It is noted that the reaction medium very rapidly turns dark brown (see FIG. 1) and the catalytic reaction stops.

### Examples 1 and 2: Hydrosilylation of 1-octene (1) with 1,1,1,3,5,5,5-heptamethyltrisiloxane (2)

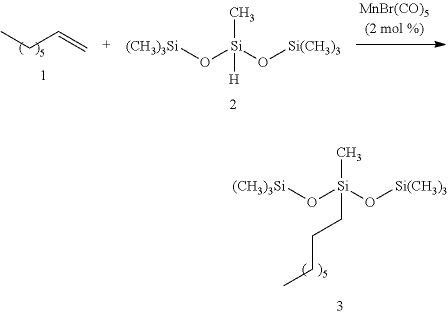

Example 1:1-Octene (1) (74 μl, 0.47 mmol) and 1,1,1,3,5,5,5-heptamethyltrisiloxane (2) (256 μl, 0.94 mmol) were introduced into a vial. A solution of MnBr(CO)₅ in toluene was injected into the vial and toluene was added. Final concentration of [Mn], relative to 1-octene=2 mol %. Total volume of toluene=195 μl. The reaction was carried out in air, without purification of the reagents and toluene.

After 4 h at 70° C., the yield of the reaction was 99%. No isomerization product of the 1-octene is detectable. No dehydrogenative silylation product was observed. The reaction is therefore selective for hydrosilylation.

Example 2: The same procedure described in example 1 (70° C., 4 h, in air without purification) was followed while using a 1:1 molar ratio of 1-octene (1) (0.94 mmol) and 1,1,1,3,5,5,5-heptamethyltrisiloxane (2) (0.94 mmol). After 4 h at 70° C., the yield of the reaction was 96%. The degree of isomerization of the 1-octene was less than 1%.

### Examples 3-16 and Comparative Examples 2-5: Hydrosilylation of Various Alkenes (1′)

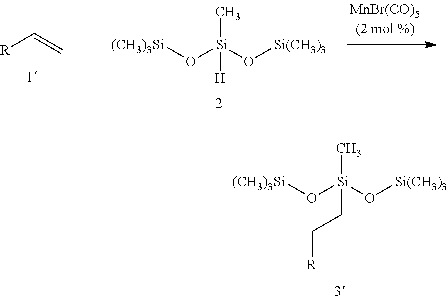

The same procedure described in example 1 (70° C., 4 h, in air, in toluene, without purification) was followed while varying the structure of the alkene compound (1′) as indicated in table 1 below. The amounts of reagents used were 1 eq. of alkene (1′) per 1 or 2 eq. of heptamethyltrisiloxane (2). The yield of hydrosilylation product (3′) (determined by gas chromatography, calculated with respect to the alkene) is given in table 1.

TABLE 1

| | | Molar ratio (1′):(2) = | Molar ratio (1′):(2) = |
|---|---|---|---|
| | | 1:2 | 1:1 |
| | Alkene (1′) | Yield of (3′) | Yield of (3′) |
| Ex. 3 | 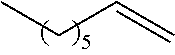 | >99% | 96% |
| Ex. 4 | 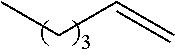 | >99% | 82% |
| Ex. 5 | 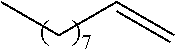 | | 98% |
| Ex. 6 | 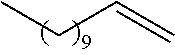 | >99% | 98% |
| Ex. 7 | 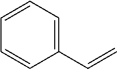 | >99% | 78% |
| Ex. 8 | 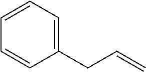 | >99% | 93% |
| Ex. 9 | 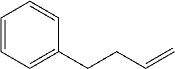 | 90% | 91% |
| Ex. 10 | 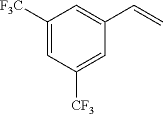 [SMILES: C=Cc1cc(C(F)(F)F)cc(C(F)(F)F)c1] | | 65% |
| Ex. 11 | 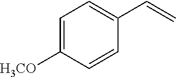 | | 75% |
| Ex. 12 | 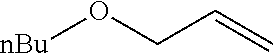 | 52% | 31% |
| Ex. 13 | 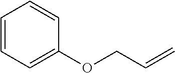 | 62% | 87% |
| Ex. 14 | 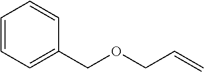 | 70% | 18% |
| Ex. 15 | 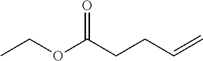 | >99% | 59% |
| Ex. 16 | 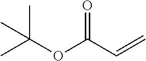 | | 87% |
| Comp. 2 | 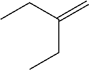 | no product | no product |
| Comp. 3 | 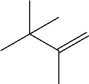 | no product | |
| Comp. 4 | 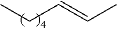 | no product | no product |
| Comp. 5 | 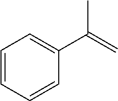 | | 7% |

In examples 3 to 16, the hydrosilylation products were obtained with excellent selectivity. No C═C isomerization or C—O bond cleavage products were observed. However, the hydrosilylation product is not obtained from gem-disubstituted alkenes (comparative examples 2, 3 and 5) or from an internal alkene (comparative example 4).

### Examples 17-33: Hydrosilylation in Various Solvents

The same procedure described in example 1 (70° C., 4 h, in air, without purification) was followed while varying the nature of the solvent and the nature of the alkene, as indicated in tables 2 and 3 below. The yield of hydrosilylation product (3) (determined by gas chromatography, calculated with respect to the alkene) is given in tables 2 and 3.

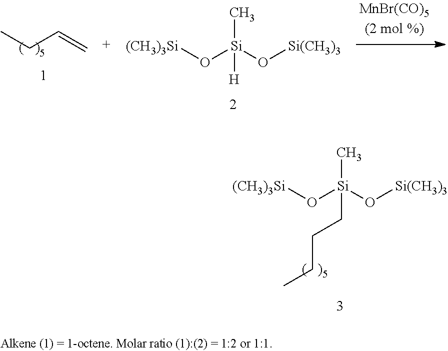

TABLE 2

| | | Molar ratio (1):(2) = 1:2 | | Molar ratio (1):(2) = 1:1 | |
|---|---|---|---|---|---|
| | | | Isomerization | | Isomerization |
| | Solvent | Yield of (3) | of (1) | Yield of (3) | of (1) |
| Ex. 17 | Anisole | 95% | no product | 95% | no product |
| Ex. 18 | Water | 99% | <1% | 85% | <1% |
| Ex. 19 | No solvent | 99% | <1% | 96% | <1% |

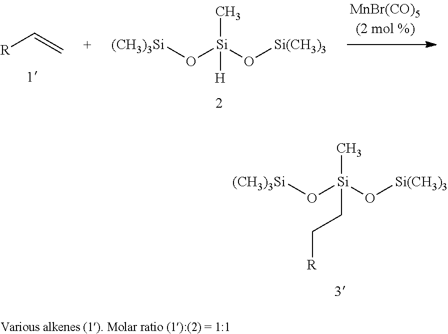

TABLE 3

| | | Solvent = anisole | Solvent = water | No solvent |
|---|---|---|---|---|
| | Alkene (1′) | Yield of (3′) | Yield of (3′) | Yield of (3′) |
| Ex. 20 | 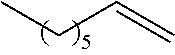 | 95% | 85% | 96% |
| Ex. 21 | 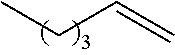 | 70% | 45% | 80% |
| Ex. 22 | 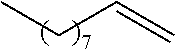 | 98% | 90% | 93% |
| Ex. 23 | 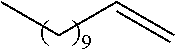 | 95% | 60% | 99% |
| Ex. 24 | 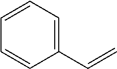 | 76% | 47% | 76% |
| Ex. 25 | 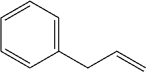 | 94% | 54% | 98% |
| Ex. 26 | 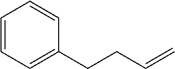 | 87% | 40% | 90% |
| Ex. 27 | 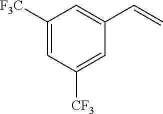 [SMILES: C=Cc1cc(C(F)(F)F)cc(C(F)(F)F)c1] | 61% | 62% | 88% |
| Ex. 28 | 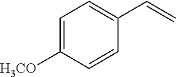 | 62% | 35% | 69% |
| Ex. 29 | 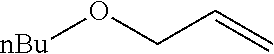 | 22% | 53% | 39% |
| Ex. 30 | 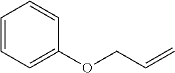 | 66% | 53% | 79% |
| Ex. 31 | 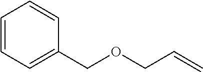 | 21% | 13% | 32% |
| Ex. 32 | 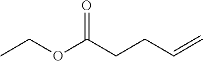 | 52% | 6% | 72% |
| Ex. 33 | 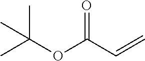 | 60% | 30% | 90% |

### Examples 34-43: Hydrosilylation of Various Silanes

Styrene (0.47 mmol, 1 eq.) and a silane compound (0.94 mmol, 2 eq.) were introduced into a vial. A solution of MnBr(CO)₅ in anisole was injected into the vial and anisole was added. Final concentration of [Mn], relative to styrene=2 mol %. The reaction was carried out in air, at 70° C., without purification of the reagents and anisole. After 4 h, the yield of hydrosilylation product (determined by gas chromatography, calculated with respect to the alkene) is given in table 4.

TABLE 4

| | Silane | Yield |
|---|---|---|
| Ex. 34 | Triethylsilane (Et₃SiH) | 79% |
| Ex. 35 | Phenyldimethylsilane (PhMe₂SiH) | >99% |
| Ex. 36 | Benzyldimethylsilane (BnMe₂SiH) | >99% |
| Ex. 37 | Diphenylsilane (Ph₂SiH₂) | 97% |

The same procedure described above for examples 34-37 (70° C., 4 h, in air, without purification) was followed while using a molar ratio of 1:1 of various alkenes and various silanes. After 4 h, the yield of hydrosilylation product (determined by gas chromatography, calculated with respect to the alkene) is given in table 5.

TABLE 5

| | | Silane = | | | | |
|---|---|---|---|---|---|---|
| | Alkene | PhMe₂SiH | BnMe₂SiH | Et₃SiH | (EtO)₃SiH | Ph₂SiH₂ |
| Ex. 38 | 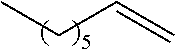 | 43% | 70% | 58% | 30% | 43% |
| Ex. 39 | 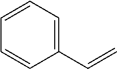 | 77% | 79% | 63% | 28% | 80% |
| Ex. 40 | 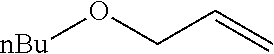 | 68% | 74 | 81% | 26% | 44% |
| Ex. 41 | 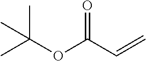 | 89% | 90% | 94% | 33% | Yld not calculated |
| Ex. 42 | 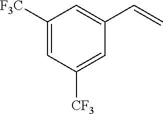 [SMILES: C=Cc1cc(C(F)(F)F)cc(C(F)(F)F)c1] | 85% | 79% | 78% | 10% | 76% |
| Ex. 43 | 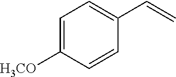 | 94% | 75% | 56% | Yld not calculated | 72% |

Examples 34 to 43 show that hydrosilylation catalyzed by MnBr(CO) works with silane compounds as well as siloxane compounds (examples 1 to 33).

### Examples 44-46: Effect of Purification of the Reagents

The same procedure described in example 1 (70° C., 4 h, in air) was followed with the exception of the solvent: anisole was used instead of toluene. Various alkene compounds (1′) were tested, with and without prior purification, as indicated in table 6 below. The amounts of reagents used were 1 eq. of alkene (1′) per 2 eq. of heptamethyltrisiloxane (2). Final concentration of [Mn], relative to 1-octene=2 mol %. The yield of hydrosilylation product (3′) (determined by gas chromatography, calculated with respect to the alkene) is given in table 6.

TABLE 6

| | | Yield of (3′) | Yield of (3′) |
|---|---|---|---|
| | | with prior purification | without prior purification |
| | Alkene (1′) | of the alkene | of the alkene |
| Ex. 44 | n-Octene | 98% | 98% |
| Ex. 45 | Styrene | >99% | 76% |
| Ex. 46 | Allylbenzene | >99% | >99% |

No significant difference could be observed between the use of a purified reagent and an unpurified reagent in examples 44 and 46. In example 45, the slight drop in yield can be explained by the presence of butylcatechol in commercial styrene. Butylcatechol is a stabilizing agent that protects commercial styrene against radical reactions. It is the cause of the drop in catalytic activity during the hydrosilylation reaction.

### Examples 47-49: Polysiloxane Crosslinking Reaction

The hydrosilylation reaction was carried out using a polymethylhydrosiloxane oil with an approximate MD′₅₀M structure (content of Si—H units about 45.5 wt. %).

Ex.47: Polymethylhydrosiloxane oil (1 eq. of SiH functions) and divinyltetramethyldisiloxane (1 eq. of C═C functions) were mixed in a vial with 0.3 mol % of MnBr(CO)₅, relative to the moles of SiH. The reaction was carried out in air, at 70° C., without prior purification. After 8 h, a gelling phenomenon was observed, which corresponds to the crosslinking of the composition.

Ex.48: Polymethylhydrosiloxane oil (1 eq. of SiH functions) and diethyl diallylmalonate (1 eq. of C═C functions) were mixed in a vial with 0.3 mol % of MnBr(CO)₅, relative to the moles of SiH. The reaction was carried out in air, at 70° C., without prior purification. After 2 h, a gelling phenomenon was observed, which corresponds to the crosslinking of the composition.

Ex.49: The unsaturated compound is an α,ω-divinyl polydimethylsiloxane oil of approximate M^{Vi}D₆₄M^{Vi} structure (content of vinyl units of approximately 1 wt. %). The MnBr(CO)₅ catalyst was diluted in toluene and mixed with a portion of the α,ω-divinyl polydimethylsiloxane oil. With stirring, the polymethylhydrosiloxane oil and the remainder of the α,ω-divinyl polydimethylsiloxane oil were added so as to achieve an SiH/SiVi molar ratio of 1.7 and an MnBr(CO)₅ content of 2 mol %, relative to the moles of SiH. The reaction was carried out at 100° C. in air. After 23 min, a gel was obtained in the entire flask.

### Examples 50-56: Reaction with Various Functionalized Alkenes

The hydrosilylation reaction was carried out using a polymethylhydrosiloxane oil with an approximate MD′₅₀M structure (content of Si—H units about 45.5 wt. %).

The same procedure described in example 47 (70° C., in air, without purification) was followed while varying the alkene compound as indicated in table 7 below. The gel time of the reaction media is indicated in table 7.

TABLE 7

| | Functionalized alkene | Gel time | |
|---|---|---|---|
| Ex. 50 | Allyl acetate | 10 | h |
| Ex. 51 | Vinyl acetate | 4 | h |
| Ex. 52 | Methyl methacrylate | 15 | min |
| Ex. 53 | Allyl methacrylate | 2.5 | h |
| Ex. 54 | Hex-5-en-2-one | 3 | |
| Ex. 55 | Allyl glycidyl ether | <10 | min |
| Ex. 56 | 1,2-epoxy-4-vinylcyclohexane | <10 | min |

Examples 50 to 56 indicate that the MnBr(CO)₅ catalyst catalyzes not only the hydrosilylation reaction between the hydrosilyl function and the C═C unsaturation, but also with the acetate groups (Ex.50 and 51), acrylate groups (Ex.52 and 53) and ketone groups (Ex.54). In examples 55 and 56, crosslinking is obtained by epoxide ring opening.

1. A process for the hydrosilylation of an unsaturated compound A comprising at least one monosubstituted alkene function, with a compound B comprising at least one hydrosilyl function, catalyzed by a complex of manganese in the I oxidation state C, in the presence of air and/or water.

2. The hydrosilylation process as claimed in claim 1, wherein the complex of manganese in the I oxidation state is selected from complexes of formula Mn(CO)₅Z, wherein Z represents a coordinating or non-coordinating anion, from the group consisting of: H⁻, F⁻, Cl⁻, Br⁻, I⁻, OH⁻, BF₄⁻, PF₆⁻, NO₃⁻, Cl0₄⁻, RCOO⁻, CF₃COO⁻, RSO₃⁻, BH₄⁻, BR₄⁻, AlR₄⁻, Al(OR)₄⁻, NH₂⁻, RO⁻, CN⁻, R₂N⁻, SCN⁻, OCN⁻, OCP⁻, RS⁻, R⁻CONH⁻, (R—CO)₂N⁻, HCO₃⁻, HSO₄⁻, H₂PO₄⁻, acetylacetonate, pentafluorobenzoate, bis(trimethylsilyl)amide, tetrakis[pentafluorophenyl]borate and tetrakis [3,5-bis(trifluoromethyl)phenyl]borate, R representing a C₁₋₁₀ alkyl group, CF₃, C₂F₅, C(CF₃)₃, a C₃₋₁₀ cycloalkyl group, a C₃₋₁₀ heterocyclic group comprising at least one N, O or S heteroatom, a C₅₋₁₀ aryl group, or a C₅₋₁₀ heteroaryl group comprising at least one N, O or S heteroatom.

3. The hydrosilylation process as claimed in claim 1, wherein the complex of manganese in the I oxidation state is manganese (I) bromopentacarbonyl, of chemical formula [MnBr(CO)₅].

4. The hydrosilylation process as claimed in claim 1, wherein the unsaturated compound A comprises one or more monosubstituted alkene functions and from 2 to 40 carbon atoms, optionally, the unsaturated compound A may be represented by the general formula (1): 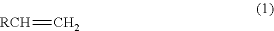
wherein R represents a monovalent radical selected from the group consisting of:
an alkyl group having between 1 and 30 carbon atoms, optionally between 1 and 12 carbon atoms, optionally between 1 and 6 carbon atoms, optionally substituted with one or more halogen atoms such as chlorine or fluorine, and optionally with one or more groups selected from —OH and —OSiR′₃, wherein each R′ represents, independently of one another, H or an alkyl group;
an aryl group having between 6 and 30 carbon atoms, optionally between 6 and 18 carbon atoms, optionally substituted with one or more halogen atoms such as chlorine or fluorine, and optionally with one or more groups selected from alkyl groups, haloalkyl groups, —OH and —OR′ and —OSiR′₃, wherein each R′ represents, independently of one another, H or an alkyl group;
an aryl-alkyl group optionally comprises between 6 and 30 carbon atoms, optionally between 7 and 20 carbon atoms, optionally substituted on the aryl part thereof and/or on the alkyl part thereof, with one or more halogen atoms such as chlorine or fluorine, and optionally with one or more groups selected from alkyl groups, haloalkyl groups, —OH and —OR′ and —OSiR′₃, wherein each R′ represents, independently of one another, H or an alkyl group;
an ether group of formula —L—O—R″, wherein L represents a bond or a divalent radical, optionally an alkylene group having from 1 to 12 carbon atoms, optionally between 1 and 6 carbon atoms, and R″ represents a group selected from: an alkyl group having between 1 and 30 carbon atoms, optionally between 1 and 12 carbon atoms, optionally between 1 and 6 carbon atoms, optionally substituted with one or more halogen atoms such as chlorine or fluorine, and optionally with one or more groups selected from —OH and —OSiR′₃, wherein each R′ represents, independently of one another, H or an alkyl group; an aryl group having between 6 and 30 carbon atoms, optionally between 6 and 18 carbon atoms, optionally substituted with one or more halogen atoms such as chlorine or fluorine, and optionally with one or more groups chosen from alkyl groups, haloalkyl groups, —OH, —OR′ and —OSiR′₃, wherein each R′ represents, independently of one another, H or an alkyl group; and an aryl-alkyl group optionally comprises between 6 and 30 carbon atoms, optionally between 7 and 20 carbon atoms, optionally substituted on the aryl part thereof and/or on the alkyl part thereof, with one or more halogen atoms such as chlorine or fluorine, and optionally with one or more groups selected from alkyl groups, haloalkyl groups, —OH, —OR′ and —OSiR′₃, wherein each R′ represents, independently of one another, H or an alkyl group;
an ester group of formula —L—C(O)—O—R″ or —L—O—C(O)—R″, wherein L and R″ have the same definitions as those given above.

5. The hydrosilylation process as claimed in claim 1, wherein the unsaturated compound A is an organopolysiloxane compound comprising one or more monosubstituted alkene functions, optionally at least two monosubstituted alkene functions.

6. The hydrosilylation process as claimed in claim 1, wherein the compound B comprising at least one hydrosilyl function is an organopolysiloxane compound comprising at least one hydrogen atom bonded to a silicon atom.

7. The hydrosilylation process as claimed in claim 1, wherein the hydrosilylation reaction is carried out in a solvent, said solvent optionally being selected from:
the group consisting of aliphatic hydrocarbons, such as pentane, hexane, heptane, cyclohexane, decalin, and liquid paraffins; aromatic hydrocarbons, such as toluene, and xylene; mixtures of hydrocarbons of mineral or synthetic origin, such as white spirit; ethers, such as tetrahydrofuran, dioxane, diethyl ether, diphenyl ether and anisole; chlorinated hydrocarbons, such as methylene chloride, 1,2-dichloroethane, perchloroethylene and chlorobenzene; esters, such as ethyl acetate, butyl acetate and butyrolactone; acetonitrile; dimethylformamide; dimethyl sulfoxide; N-methylpyrrolidone; polyethylene glycols; water; and mixtures thereof;
volatile silicones, octamethylcyclotetrasiloxane (D4), decamethylcylopentasiloxane (D5), polydimethylsiloxane (PDMS) oils, polyphenylmethylsiloxane (PPMS) oils or mixtures thereof;
the solvent optionally being selected from the group consisting of water, anisole and ethyl acetate, optionally water and anisole.

8. The hydrosilylation process as claimed in claim 1, wherein the reagents and solvents are used without a prior purification step.

9. The hydrosilylation process as claimed in claim 1, for the functionalization of organopolysiloxanes with SiH functions, wherein the unsaturated compound A comprising at least one monosubstituted alkene function is chosen from unsaturated compounds comprising one or more monosubstituted alkene functions and from 2 to 40 carbon atoms, and the compound B comprising at least one hydrosilyl function is an organopolysiloxane compound comprising at least one hydrogen atom bonded to a silicon atom.

10. The hydrosilylation process as claimed in claim 1, for the preparation of crosslinked silicone materials, wherein the unsaturated compound A comprising at least one monosubstituted alkene function is an organopolysiloxane compound comprising at least two monosubstituted alkene functions, and the compound B comprising at least one hydrosilyl function is an organopolysiloxane compound comprising at least three hydrogen atoms bonded to a silicon atom.
